(19) United States
(12) Patent Application Publication
(10) Pub. No.: US 2024/0001301 A1
(43) Pub. Date: Jan. 4, 2024

(54) A DESALINATION PLANT

(71) Applicant: GENIUS WATTER S.R.L., Carmignano di Brenta (PD) (IT)

(72) Inventors: Franco TRAVERSO, Carmignano di Brenta (PD) (IT); Dario TRAVERSO, Asolo (TV) (IT)

(73) Assignee: GENIUS WATTER S.R.L., Carmignano di Brenta (PD) (IT)

(21) Appl. No.: 18/038,415

(22) PCT Filed: Nov. 23, 2021
(86) PCT No.: PCT/IB2021/060864

§ 371 Date: May 23, 2023

(30) Foreign Application Priority Data
Nov. 26, 2020 (IT) 102020000028553

(51) Int. Cl. B01D 61/12; B01D 61/02; B01D 61/10; C02F 1/44; C02F 1/00

(52) U.S. Cl. CPC B01D 61/12; B01D 61/026; B01D 61/10; C02F 1/441; C02F 1/008; B01D 2313/18; B01D 2317/04; B01D 2313/367; B01D 2313/243; B01D 2313/701; B01D 2313/60; C02F 2209/006; C02F 2209/40; C02F 2209/03; C02F 2301/08; B01D 2317/02; C02F 2201/009; C02F 2201/005; C02F 2103/08

(57) ABSTRACT

Renewable energy desalination plant for the treatment of a fluid includes:
a treatment unit equipped with first and second reverse osmosis filtration devices for desalinating of a flow of fluid to be treated, the first and second devices being connected in parallel;
first pump positioned upstream of the treatment unit;
means for generating electrical energy from renewable energy to supply electricity to the first pump,
a supply duct which is fluidically and separately connected with the inlet of the first device and with the inlet of the second device the treatment unit, to supply the two devices with the fluid to be treated,
a shut-off/regulating valve which is positioned at the fluidic connection of said supply duct with the first device,
an electronic control unit electronically connected to the shut-off/regulation valve;
electronic sensors connected to the electronic control unit configured to detect irradiation and/or the intensity of electric current generated.

### FIELD OF THE INVENTION

The present invention relates to a desalination plant, in particular powered by renewable energy, or a plant used to soften a fluid and in particular water with a large quantity of saline compounds in solution, such as brackish and/or sea water. This desalination plant is advantageously used in those areas of the world where the supply of suitably clean and/or potable water is difficult, such as for example developing countries or sparsely inhabited and/or industrialized islands.

The plant in question makes it possible to make the water, in particular brackish and/or sea water, drinkable and/or usable by the local population, since such water is in nature non-drinkable or usable at industrial level or in agriculture as having a large amount of saline compounds in solution.

The present invention therefore finds advantageous use in the technical sector of the production, marketing and installation of water treatment plants and in particular in the technical sector of the production, marketing and installation of desalination plants.

### BACKGROUND

Desalination plants comprising at least one desalination device, such as in particular a reverse osmosis filtration device (also known with the term “hyperfiltration” or with the acronym RO) have been known for some time in the technical reference sector mentioned above.

As is known per se, reverse osmosis makes it possible to separate the solute from a solvent of a solution by means of the forced passage of the latter through a porous membrane. In other words, reverse osmosis provides for the aforementioned at least one membrane capable of retaining the solute on one side (in which there is therefore the most concentrated solution, known with the technical term of “concentrate”) preventing its passage and allowing to obtain the solvent (substantially) purified from the other (known by the technical term of “permeate”). For this process to take place, it is necessary to apply a pressure greater than its osmotic pressure to the solution crossing the membrane.

Known reverse osmosis systems therefore comprise at least one feed/extraction pump, located at the source of brackish or sea water, hydraulically connected to the aforementioned reverse osmosis filtration device by means of at least one high pressure pump, necessary to overcome the aforementioned osmotic pressure and allow desalination.

It is also known to realize desalination plants with two or more reverse osmosis filtration devices placed together hydraulically in parallel downstream of the high-pressure pump, in order to increase the efficiency and the flow of treatable water per unit of time.

The aforementioned feed/extraction pump and the aforementioned high-pressure pump are normally operated by a respective electric motor, electrically powered by means for the generation of electrical energy known per se and in particular, in recent years, these feed means have been normally of the renewable type, such as photovoltaic and/or wind power.

In this way, the desalination plant is able to operate substantially autonomously, obviating the need for an electricity supply from an electricity network.

However, these known types of plants have proved to be not free from drawbacks in practice.

The main drawback resides in the fact that the water typically treated by the systems described above varies on the basis of the electrical power made available by the renewable source power supply means. More in detail, it is notorious that renewable source power supply means do not supply electricity constantly during the day, as this energy is a function of the meteorological variable, that is, it is a function of the sun's irradiation or the strength of the wind.

Consequently, the mechanical power that can be supplied by the electric motors that activate the pumps also varies during the day based on the different weather conditions and therefore the quantity of brackish and/or sea water treated is also variable.

In this situation, a reverse osmosis desalination plant of the type described involves significant variations in the production of the treated water throughout the day and therefore involves a consequent non-optimal use of the membranes which, in the presence of this variable operation, can operate with solution flows that pass through them that are not ideal, that is, different from those for which they were designed.

Consequently, due to the aforementioned variable functioning given by the variability of the means for the generation of renewable electricity, the membranes of reverse osmosis filtration devices often run into premature impoverishment, inevitably leading to their necessary replacement in a short time, effectively increasing the plant management and maintenance costs.

### SUMMARY

Therefore, the main object of the present invention is to propose a desalination plant which allows to obviate the drawbacks of the aforementioned known art.

Another object of the invention is to provide a desalination plant which is perfectly reliable even if powered by means for the generation of renewable electricity.

Another object of the invention is to propose a desalination plant which allows the reverse osmosis membranes to be used in an optimal manner in all weather conditions.

Another object of the invention is to propose a desalination plant which is constructively simple and completely reliable.

Another object of the invention is to propose a desalination plant which allows to limit management costs, and in particular which allows to limit maintenance costs.

Another object of the invention is to propose a desalination plant which allows it to be used continuously throughout an operating day.

Another object of the invention is to propose a desalination plant which is easily achievable and with low costs.

Another object of the invention is to propose a desalination plant which is an alternative and/or an improvement with respect to known solutions.

All these purposes, both individually and in any combination thereof, and others which will result from the following description, are achieved, according to the invention, with a desalination plant as set forth below.

### BRIEF DESCRIPTION OF THE DRAWINGS

The present invention is further clarified hereinafter in a preferred embodiment thereof, reported for purely illustrative and non-limiting purposes with reference to the attached drawings, in which:

FIG. 1 shows a schematic circuit view of a desalination plant according to the present invention in a first embodiment;

FIG. 2 shows a schematic circuit view of a detail of the plant of FIG. 1, in a second embodiment;

FIG. 3 shows a schematic circuit view of a detail of the plant of FIG. 1, in a third embodiment;

FIG. 4 shows a schematic circuit view of a detail of the plant of FIG. 1, in a fourth embodiment;

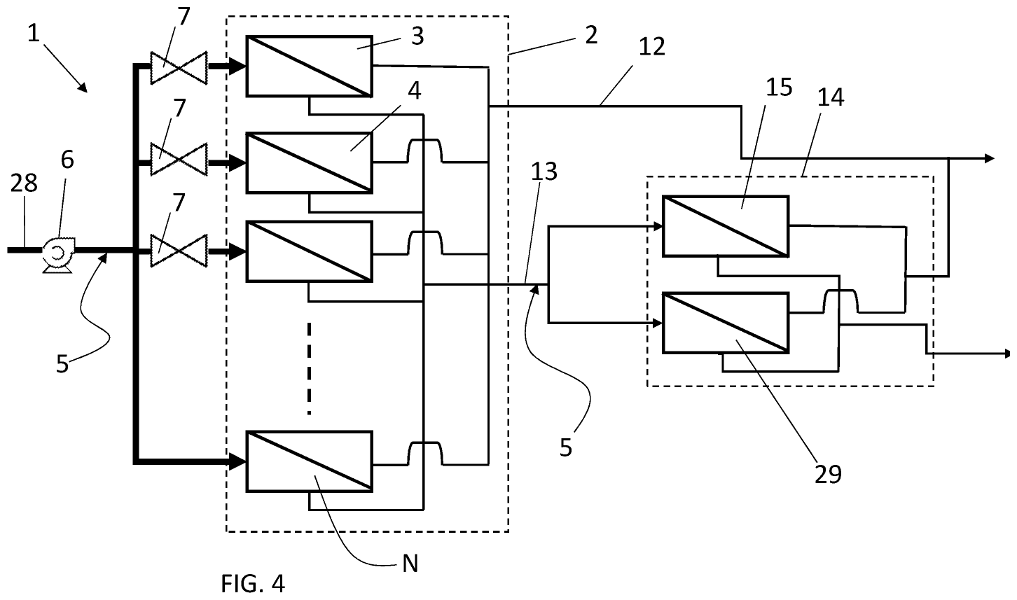

FIG. 5 shows a schematic circuit view of a detail of the plant of FIG. 1, in a fourth embodiment;

FIG. 6 shows a schematic and simplified view of a detail of the plant of FIG. 1, concerning a reverse osmosis filtration device;

FIG. 7 shows a schematic view of a detail of the plant of FIG. 1, in which respective throttling valves are provided on the concentrate outlet ducts of two reverse osmosis filtration devices in cascade;

FIG. 8 shows a schematic view of a detail of the plant of FIG. 1, in which a throttling valve is provided on the concentrate outlet duct of a downstream reverse osmosis filtration device,

FIG. 9 shows a schematic view of a detail of the plant of FIG. 1, in which a throttling valve is provided on the concentrate outlet duct of an upstream reverse osmosis filtration device.

### DETAILED DESCRIPTION OF THE PREFERRED EMBODIMENTS

The renewable energy desalination plant according to the invention has been identified as a whole with the reference 1 in the attached figures.

This desalination plant 1 according to the present invention finds advantageous use in those areas of the world where the supply of clean and/or drinkable water is difficult, such as for example developing countries or sparsely inhabited and/or industrialized islands.

The plant in question makes it possible to make water, in particular brackish water, generally non-potable and/or unusable as it contains too many saline compounds in solution, usable for any purpose by the local population.

The present invention therefore finds advantageous use in the technical sector of the production, marketing and installation of water treatment plants and in particular in the technical sector of the production, marketing and installation of desalination plants.

The desalination plant 1 for treating water according to the present invention comprises at least one treatment unit 2, 14 equipped with at least a first reverse osmosis filtration device 3, 15 for the desalination of a flow of fluid to be treated, for example amarine and/or brackish water, and at least a second reverse osmosis filtration device 4, 29 for the desalination of a flow of fluid to be treated, for example sea and/or brackish water, arranged in parallel with respect to the first device 3, 15.

The at least one second device 4, 29 and the at least one first device 3, 15 are connected in parallel, in accordance with the embodiments illustrated in the attached figures.

Conveniently, said at least one first device 3 and said at least one second device 4 can be provided in a first treatment unit 2 which, preferably, defines the only treatment unit of said plant or an upstream treatment unit of a plant with two or more treatment units in cascade.

Conveniently, said at least one first device 15 and said at least one second device 29 can be provided in a second treatment unit 14 which is positioned immediately downstream of said first upstream treatment unit 2.

Conveniently, it is understood that the plant 1 could have only the first treatment unit 2.

Conveniently, it is understood that the treatment unit 2 can comprise N reverse osmosis filtration devices, with N equal to or greater than two, in parallel with each other.

Conveniently, it is understood that the downstream treatment unit 14 can comprise N reverse osmosis filtration devices, with N equal to or greater than two, in parallel with each other.

With the term “reverse osmosis filtration device” it is meant, within the meaning of this description, a water treatment device, per se known, which is configured to treat a flow of water through the use of semipermeable membranes.

Preferably, the aforementioned at least one first reverse osmosis filtration device 3, 15 and the corresponding at least one second reverse osmosis filtration device 4, 29 of the same treatment unit are equal to each other, in particular in terms of configuration and filtering capacity and/or treatment of fluids. Preferably, the devices of the same treatment unit are equal to each other in terms of configuration and filtering and/or treatment capacity of the fluids, and in particular the devices 3, 4 of the upstream treatment unit 2 have identical characteristics, and different from those of the devices 15, 29 of the downstream treatment unit 14.

More in detail, the semipermeable membranes of said devices are configured to be crossed by the aforementioned water flow, at high pressure, and to block at least partially impurities, and in particular salts, dissolved in solution within the water itself, due to the physical principle of reverse osmosis.

By “reverse osmosis” we mean a process of purification of water (and more generally of any fluid) that contains substances in solution, through a very fine filtering system that allows only the water molecules to pass. The principle is based on the fact that if two solutions of different solute concentrations (normally salt) are placed in two sectors separated by a filter membrane, the water of one sector will pass through the membrane by osmosis until the concentrations equalize or the pressure difference exceeds the osmotic pressure. The movement of water therefore reduces the concentration of solute (in particular of salt) in the permeate sector and increases it in the concentrate sector (and corresponding to the sector of origin of the water to be filtered). Conversely, by exerting, in one of the sectors, a hydrostatic pressure that exceeds the osmotic pressure, the water is forced to leave the sector under pressure despite the increase in the concentration of solute that occurs there and despite the dilution that occurs in the other compartment.

The plant according to the invention is advantageously intended to be used for the desalination of sea or brackish water, in particular by reverse osmosis, thus using the pressurization of the fluid to be treated (i.e. sea or brackish water) above its osmotic pressure in order to allow the permeation of water alone (without the dissolved salts) through a semipermeable membrane.

The process is said to be “reverse” because it requires sufficient pressure to “force” the treated water to pass through the membrane. This process normally eliminates 98% to 99% of the solids dissolved in solution.

Many types and models of different reverse osmosis filtration devices are known on the market. For the purposes of the plant object of the present invention, it must be understood that any type and/or model of reverse osmosis filtration device known per se to the skilled in the art is applicable to the desalination plant described below.

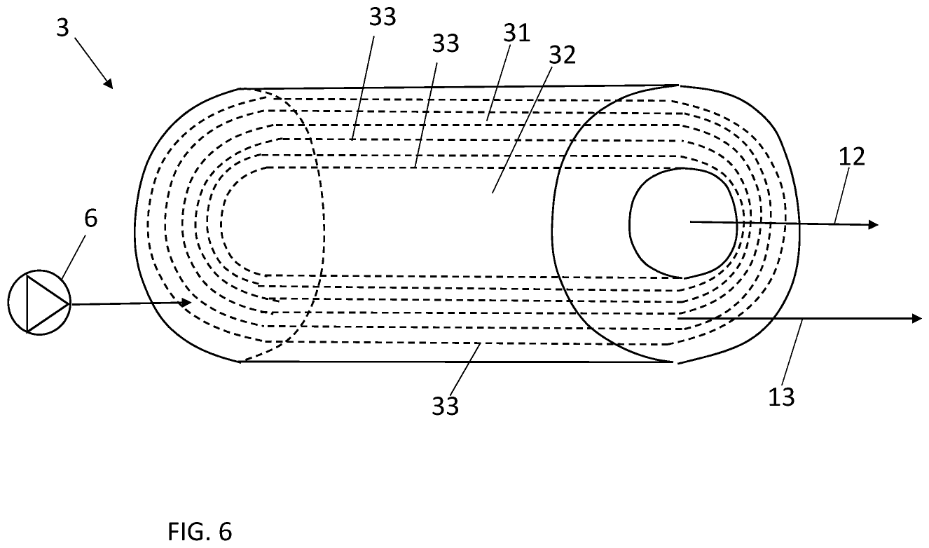

Advantageously, each reverse osmosis filtration device can comprise at least one membrane module such as the one represented schematically and simplified in FIG. 6. Advantageously, each reverse osmosis filtration device, and in particular each membrane module, is configured to implement tangential filtration of the fluid to be treated. Conveniently, each membrane module comprises a first zone 32 (preferably defined by a central tube) into which the permeate enters and around which the filter membrane 33 is wrapped, in particular several times. Therefore, the filter membrane 33 is conveniently housed in a second zone 31, in which the fluid to be treated flows, which has an annular or helical development and is arranged around the first zone 32.

Preferably, each reverse osmosis filtration device can comprise a container (vessel) inside which a membrane module or a plurality of membrane modules arranged one after the other.

Preferably, in accordance with the preferential but non-limiting embodiment illustrated in the attached figures, the plant 1 comprises means for the generation of electricity 8 from renewable energy, preferably of the photovoltaic type, for the electrical supply of at least first pumping means 6 positioned upstream of said at least one treatment unit 2, 14.

Advantageously, the plant further comprises at least one supply duct 5 which is fluidically and separately connected to the inlet of said at least one first device 3, 15 and with the inlet of said at least one second device 4, 29 of said at least one treatment unit 2, 14, to supply said two devices 2, 14 with said fluid to be treated.

The term “fluid to be treated” shall hereinafter be understood as any water-based fluid, in particular a fluid substantially containing in solution with undesirable substances such as salts and/or other compounds that make the water non-drinkable and/or usable. An example of fluid to be treated can be sea water and/or brackish water which is withdrawn by the second pumping means 17, as described below. Furthermore, the fluid to be treated could be, for example, a concentrated fluid flow, coming out from an upstream treatment unit of the same plant 1 according to the invention or of a further plant, and therefore already subjected to at least one desalination treatment or any other type of treatment, be it filtering, sterilization, or the like.

Therefore, seawater and/or brackish water withdrawn and/or entering the plant 1 circulates in the supply duct 5 of the first/only treatment unit 2, while in the supply duct 5 of the second treatment unit 14 circulates the concentrate leaving at least one device of the first upstream treatment unit 2. In other words, the supply duct 5 can comprise the inlet duct 28 for sea and/or brackish water or it can comprise the concentrate discharge duct of an upstream treatment unit.

Conveniently, each reverse osmosis filtration device 3, 4, 15 and 29 comprises an inlet which is fluidly connected to the aforementioned at least one supply duct 5.

Furthermore, the reverse osmosis filtration device 3, 4, 15, 29 also comprises a permeate outlet, which is fluidically connected to at least a first discharge duct 12 of permeate fluid, and a concentrated outlet, which is fluidically connected to at least one second discharge duct 13 of concentrated fluid.

The system also conveniently provides first pumping means 6 placed on the supply duct 5 to force the passage of the fluid to be treated inside said first reverse osmosis filtration device 3 and inside said second reverse osmosis filtration device 4.

Advantageously, the first pumping means 6 comprise at least one pump—preferably a plurality of pumps—at high pressure 19 placed on the supply duct 5 and configured to push the flow of fluid to be treated with a flow rate and/or a pressure high enough to allow the correct operation of the reverse osmosis filtration devices 3, 4.

In particular, said at least one high pressure pump 19 of the first pumping means 6 is designed to impart to the flow of fluid to be treated a pressure higher than or equal to the necessary osmotic pressure to allow the treatment to take place inside the first and/or second reverse osmosis filtration device 3, 4.

The system advantageously also provides second pumping means 17 configured to be arranged in correspondence with a source of fluid to be treated 18, such as for example a well or a basin of brackish or sea water and to push this fluid to be treated through a conduit of the inlet pipe 28 towards the first pumping means 6. Conveniently, the water of the inlet pipe 28, suitably compressed by the first pumping means 6, enters the supply duct 5 of the first/only treatment. In a possible embodiment, here not shown, the plant may not have second pumping means 17 for extracting the water to be treated, and for example the water to be treated could reach the first pumping means 6 as it is positioned at a higher geodetic level.

In accordance with a first embodiment, the second pumping means 17 comprise at least one low-pressure pump and, in particular, can comprise at least one emerged and/or submerged pump configured to withdraw the fluid to be treated. The term “low pressure pump” will hereinafter be understood as a pump designed and configured to operate at a nominal pressure generally lower than 10 bar. Conveniently, the second pumping means 17 can for example comprise any other type of pump (per se well known skilled in the art and therefore not described in detail below), such as for example a volumetric pump or a centrifugal pump.

Preferably, the plant 1 according to the invention further comprises at least one filtering station 20 placed to intercept the inlet duct 28 and advantageously placed upstream of the first pumping means 6 and preferably interposed between the first pumping means 6 and the second pumping means 17.

The filtering station 20 makes it possible to significantly lower the risk of clogging of the reverse osmosis filtration devices 3, 4 due to brackish or sea water, notoriously rich in many suspended solid particles which can clog the semipermeable membranes of the devices themselves. Furthermore, the filtering station 20 defines a safety filter for the high pressure pump of the first pumping means 6. Advantageously, the filtering station 20 can provide an antiscalant water treatment unit to reduce its hardness and avoid the accumulation of alkaline substances on the membranes of the treatment units.

Conveniently, the plant 1 according to the invention comprises at least one interception and/or regulation valve 7 which is positioned at the fluidic connection of the supply duct 5 with the first device 3 or 15.

Furthermore, the plant 1 advantageously comprises an electronic control unit 9 which is electronically connected to the interception and/or regulation valve 7 and which is programmed to command, following the reception of at least one detection signal, the complete or partial closure of the interception valve 7 and/or adjustment so as to completely stop and/or partially decrease the flow of fluid to be treated at the inlet of the first device 3 and thus increase the flow of fluid to be treated at the inlet of the at least one second device 4.

Advantageously, the system 1 comprises at least an interception and/or regulation valve 7 arranged to intercept said supply duct 5 and controlled for decrease at least one of a first flow of fluid to be treated directed to the first device 3, 15 and a second flow of fluid to be treated directed to the second device 4, 29 and thus increase at least the other between the second flow of fluid to be treated and the first flow of fluid to be treated.

In this way, the plant 1 object of the present invention allows to maintain an optimal functioning and treatment of the water in every operating condition, as described in detail below.

Advantageously, the interception and/or regulation valve 7 of the plant according to the invention is for example configured to completely interrupt and/or partially reduce the flow of fluid to be treated at the inlet of a reverse osmosis filtration device, so as to divert the flow of fluid to be treated towards the other reverse osmosis filtration device, to thus allow the latter to operate above a predetermined flow rate threshold value.

The semipermeable membranes of the reverse osmosis filtration devices 3, 4 are designed and manufactured in such a way as to work optimally when they are crossed by a flow of fluid to be treated greater than or equal to a predetermined threshold value, for example equal to 30%-40% of the nominal design flux, as generally recommended by the membrane supplier.

In other words, if for example the flow of fluid to be treated drops to a value below a predetermined threshold value, for example it is equal to 20% of the nominal flow, the reverse osmosis filtration devices 3, 4 and in in particular, their semipermeable membranes are subject to rapid and/or premature aging, due to a non-optimal and different functioning compared to that for which they were designed.

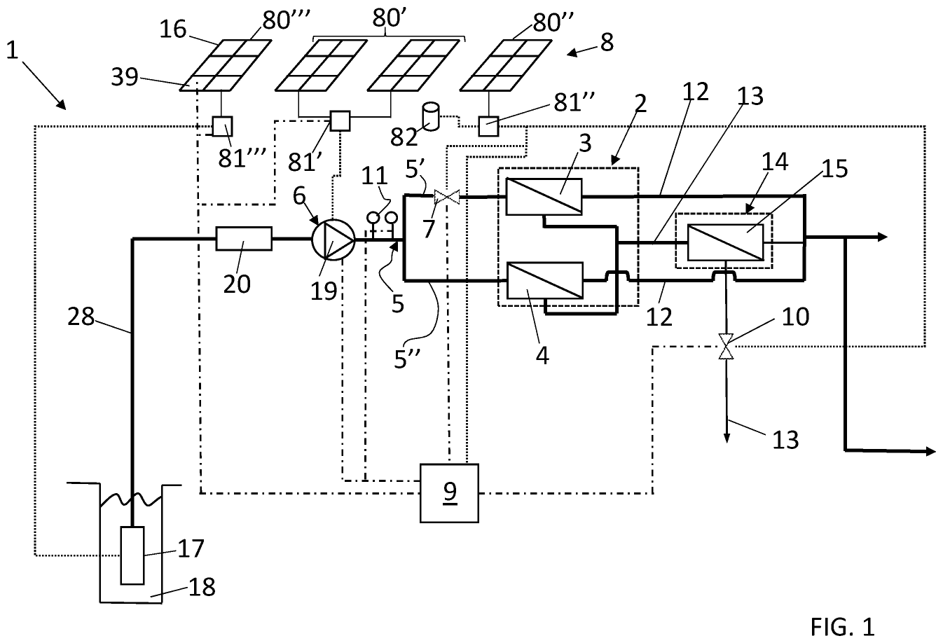

In accordance with the first embodiment of the present invention illustrated in the attached FIG. 1, the shut-off and/or regulation valve 7 is provided only in correspondence with the fluidic connection of the supply duct 5 with the first device 3 and is connected at the inlet with the supply and outlet conduit 5 is fluidically connected only with the aforementioned at least one first reverse osmosis filtration device 3. In particular, the interception and/or regulation valve 7 is selectively controlled in closing/opening to only decrease the flow of fluid to be treated at the inlet of said first device 3 (according to the present description also indicated with the term “first flow of fluid to be treated”), and thus increase the flow of fluid to be treated at the inlet of said at least one second device 4 (according to the present description also indicated with the term “second flow of fluid to be treated”).

Conveniently, in accordance with this first embodiment of the present invention, the plant 1 does not provide any interception and/or regulation valve 7 at the fluidic connection of the supply duct 5 with the second device 4. In other words, in accordance with the first embodiment, the plant does not provide any valve 7 placed to intercept the second flow of fluid to be treated directed to the second reverse osmosis filtration device 4.

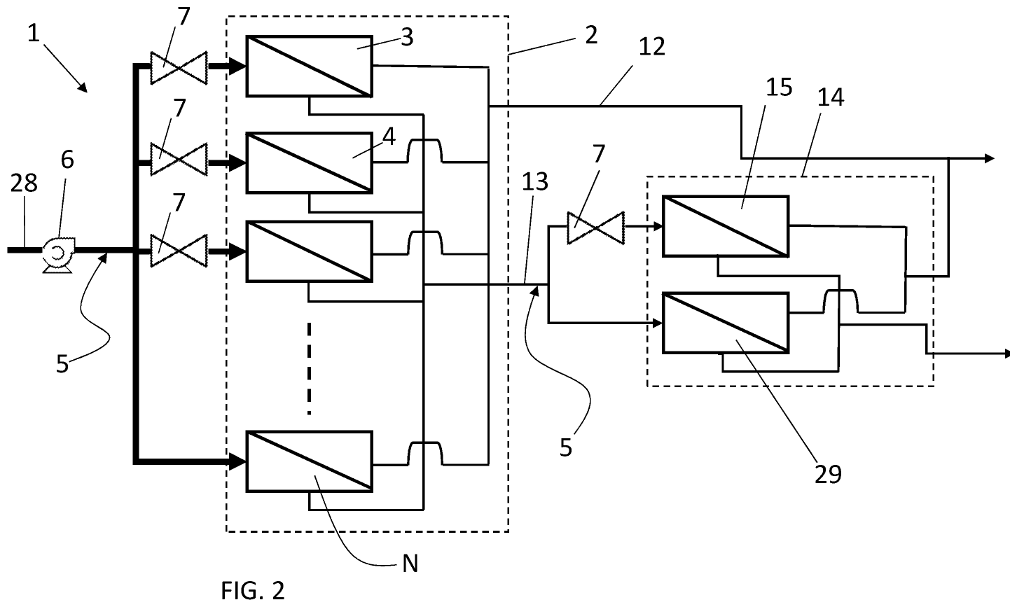

Conveniently, in accordance with a possible embodiment of the present invention (see FIG. 2), the treatment unit 2 (but this can also apply to any downstream treatment unit 14) of the plant 1 foresees N (with N equal to or greater than 2) reverse osmosis filtration devices in parallel with each other and N−1 shut-off and/or regulation valves 7, each of which is positioned upstream of respective N−1 reverse osmosis filtration devices. Therefore, in this case, no shut-off and/or regulating valve 7 is provided upstream of at least one reverse osmosis filtration device.

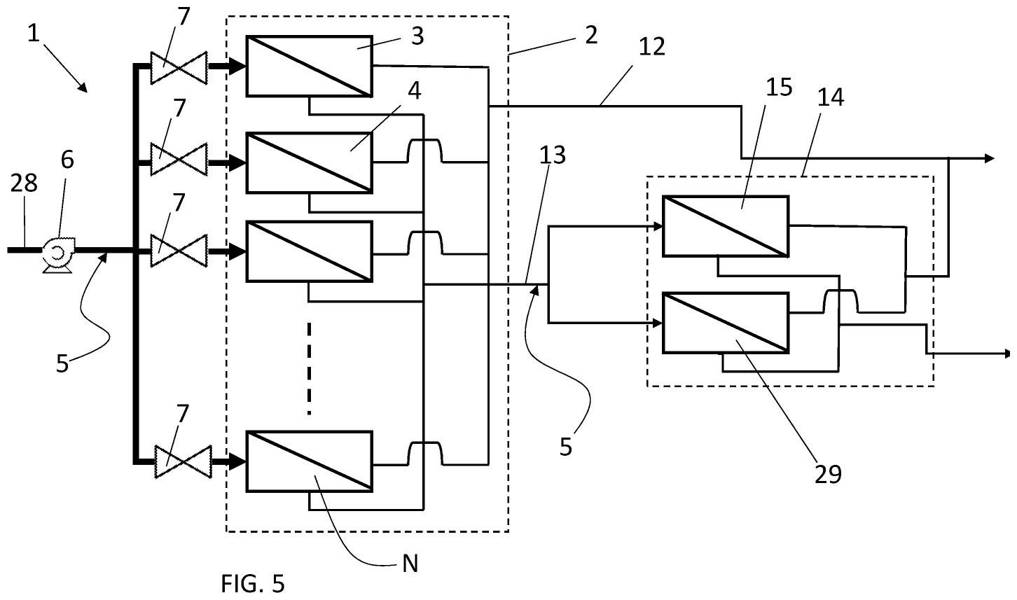

Conveniently, in accordance with a further possible embodiment of the present invention (see FIG. 5), the treatment unit 2 (but this can also apply to any treatment unit 14 downstream) of the plant 1 provides for N (with N equal to or greater than 2) reverse osmosis filtration devices in parallel with each other and N shut-off and/or regulation valves 7, each of which is positioned upstream of a respective reverse osmosis filtration device. Therefore, in this case, corresponding shut-off and/or regulating valves 7 are provided upstream of all the reverse osmosis filtration devices of the treatment unit. Conveniently, in this case, the electronic control unit 9 is configured to control alternatively, and preferably never simultaneously, the complete closure of said interception and/or regulation valves 7. In particular, in an alternating way, a condition occurs in which at least one shut-off and/or regulation valve 7 or N−1 shut-off valves 7 are closed completely or partially, to interrupt or reduce the flow of fluid to be treated at the inlet. to the respective devices positioned downstream of the valves thus closed, and thus increase the flow of fluid to be treated entering at least one device which is positioned downstream of the valve which is not closed.

More in detail, for example, in the case of two devices 3 and 4 both provided upstream with respective and dedicated shut-off and/or regulation valves 7, it will be possible to have:
a first operating condition in which the total or partial closure of the interception and/or regulation valve 7 at the inlet to the first reverse osmosis filtration device 3 causes the interruption and/or decrease of the flow of fluid to be treated at the inlet of the first device 3 (i.e. the first flow of fluid to be treated which crosses the first supply branch 5′) and thus increases the flow of fluid to be treated at the inlet of the second device 4 (i.e. the flow of fluid to be treated which passes through the second supply branch 5″),
a second operating condition in which the total or partial closure of the further interception and/or regulation valve 7 provided at the inlet to the second reverse osmosis filtration device 4 causes a decrease in the flow of fluid to be treated at the inlet of said second device 4 and thus increases the flow of fluid to be treated entering the first device 3 (i.e. the flow of fluid to be treated which crosses the first supply branch 5′).

Preferably, as said, the aforesaid two operating conditions, and in particular the closure of the respective valves, do not occur simultaneously, but advantageously always and only alternately. Conveniently, in this way all reverse osmosis filtration devices are treated in the same way in parallel, substantially leading them to have the same useful life.

Advantageously, the electronic control unit 9 is configured so that, if (in the face of minimal irradiation) the inlet flow to both reverse osmosis filtration devices in parallel is lower than a predetermined threshold value (and this despite the closure of the on-off valve 7), then correspondingly commands the deactivation/blocking of the first pumping means 6.

Advantageously, in a possible embodiment (see FIG. 1) the on-off and/or regulating valve 7 can be connected at the inlet with a supply duct 5 provided with the aforementioned first pumping means 6, to send the fluid to be treated inside a first treatment unit 2, and at the outlet it is fluidically connected only with the aforementioned at least one first device 3 of reverse osmosis filtration of the first treatment unit 2 itself which, preferably, defines the only treatment unit of the plant 1 or a upstream treatment unit of a plant with two or more treatment units in cascade (in accordance with the embodiments illustrated in the attached figures).

The interception and/or regulation valve 7 of the plant 1 object of the present invention allows, in a controlled manner, to force the passage of flow of fluid to be treated through a predetermined number of supply branches 5′, 5″ of the supply 5 to selectively and controllably increase the flow only in these latter branches and allow the corresponding reverse osmosis filtration devices 3, 4 to work in an optimal manner.

In accordance with the possible exemplary but non-limiting embodiment illustrated in FIG. 1, the interception and/or regulation valve 7 is placed in the first branch 5′ of the supply duct 5 to interrupt or partially decrease the passage of the first fluid flow to be treated and force its passage towards the second branch 5″ of the supply duct 5 and consequently increase the flow of fluid to be treated and thus allow the second reverse osmosis filtration device 4 to work through which a flow of fluid to be treated is greater than a predetermined one threshold value.

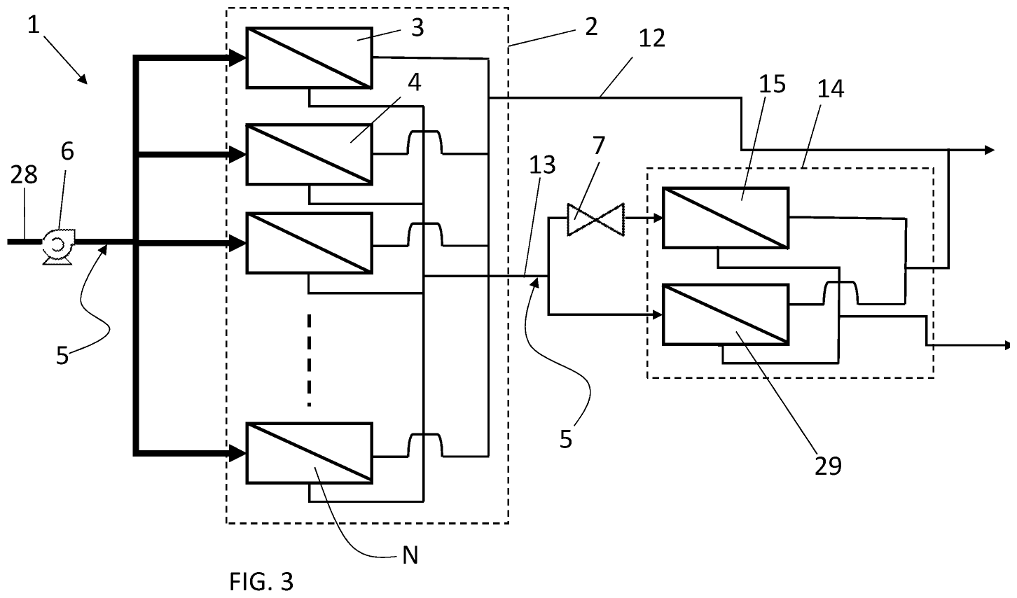

Advantageously, in accordance with a further embodiment, for example illustrated in the attached FIG. 3, the interception and/or regulation valve 7 is provided upstream of a reverse osmosis filtration device 15 of a second treatment unit 14 (which is downstream from a first upstream treatment unit 2) and is fluidically connected at the inlet with the supply duct 5 which is fluidically connected with the concentrate outlet of at least one reverse osmosis filtration device of a first upstream treatment unit 2. Conveniently, the interception and/or regulation valve 7 at the outlet is fluidically connected at the inlet with the concentrate outlets of all the reverse osmosis filtration devices of the upstream treatment unit 2 (as shown in the figures) or it could be connected at the inlet with the outlet of one, or in any case a subgroup, of the reverse osmosis filtration devices of the upstream treatment unit 2.

Conveniently, the aforementioned electronic control unit 9 comprises a microcontroller, for example a PLC or the like and, preferably, comprises at least a receiving module, a processing module and a command module, as described in detail below.

Conveniently, the means for generating electrical energy 8 comprise at least one group of photovoltaic panels in series and/or parallel configured to generate electrical power supply by solar radiation, in a manner known per se to those skilled in the art and therefore not described in details below.

Advantageously, the means for generating electric energy 8 of the renewable type are electrically connected to the electronic control unit 9.

Conveniently, the means for generating electric energy 8 of the renewable type are electrically connected to the first pumping means 6 to supply so the electric power supply.

Preferably, the means for generating electric energy 8 of the renewable type are electrically connected to the second pumping means 17 to thus supply the electric power supply.

Preferably, the means for generating electric energy 8 of the renewable type are electrically connected to said at least one shut-off and/or regulating valve 7 to thus supply the electric power supply.

Preferably, the means for generating electric energy 8 of the renewable type are electrically connected to said at least one throttle valve 10 to thus supply the electric power supply.

Preferably, the means for generating electric energy 8 of the renewable type are electrically connected to the electronic control unit 9 to thus supply the electric power supply.

Preferably, the renewable-type means for generating electrical energy 8 can be electrically connected to any/other electrical users (for example a storage battery and/or lighting means) provided in the system, to supply the electrical energy power supply.

Advantageously, the means for generating electrical energy 8 comprise at least a first dedicated group 80′—preferably two groups—of photovoltaic panels for the electrical supply of the first pumping means 6. Advantageously, said at least a first dedicated group 80′ of photovoltaic panels is connected to the first pumping means 6 by means of a first solar inverter (also called solar converter) 81′.

Advantageously, the means for generating electrical energy 8 comprise at least a second dedicated group 80″ of photovoltaic panels for the electrical supply of said at least one interception and/or regulation valve 7, of at least one throttling valve 10 and/or of said electronic control unit 9. Preferably, the second group 80″ of photovoltaic panels electrically charges a storage battery 82. Preferably, the second group 80″ of photovoltaic panels is also connected to other users (lighting means, control cameras, etc.) for their power supply. Advantageously, said at least a second dedicated group 80″ of photovoltaic panels is connected to the respective users to be powered by means of a second solar inverter (also called solar converter) 81″.

Advantageously, the means for generating electrical energy 8 comprise at least a third dedicated group 80′″ of photovoltaic panels for powering the second pumping means 17. Advantageously, said at least a third dedicated group 80′″ of photovoltaic panels is connected to the second pumping means 17 by means of a third solar inverter (also called solar converter) 81′″.

Conveniently, the solar inverters 81′, 81″ and 81′″ are of the traditional type and commonly available on the market. Advantageously, the first 81′ and/or the third inverter 81′″ are configured to perform the DC/AC conversion, to implement an MPPT protocol and to control the variable output frequency based on the input power supplied by the respective groups of photovoltaic panels. Advantageously, the second inverter 81″ is configured to output a constant voltage and constant frequency.

Conveniently, the electronic control unit 9 is electronically (via wire or via wireless) connected to said at least one interception and/or regulation valve 7, to send corresponding control signals and/or receive corresponding status signals.

Conveniently, the electronic control unit 9 is electronically connected (via wire or wirelessly) to said at least throttle valve 10, to send corresponding control signals and/or receive corresponding status signals.

Preferably, the electronic control unit 9 can be electronically connected (via wire or wirelessly) with the first pumping means 6 and/or with the second pumping means 17, to send corresponding control signals and/or receive corresponding signals of state. The system also comprises sensor means electronically connected to said electronic control unit 9 configured to detect variations in irradiation and/or to detect the intensity of electric current generated by said means for generating electric energy 8 and/or to detect a measurement of flow rate and/or pressure of said flow of fluid to be treated, and to thus send a corresponding said detection signal to said electronic control unit 9.

Conveniently, the detection signal comprises solar quantities and/or electrical quantities (for example in DC or AC current) and/or hydraulic quantities (in particular flow rate and/or fluid flow). Advantageously, the detection signal comprises detection and/or measurement quantities all directly or indirectly dependent on solar irradiation.

Advantageously, moreover, the system 1 comprises first sensor means electronically connected to the electronic control unit 9 and comprising at least one irradiation sensor 39 (preferably installed on the photovoltaic panels of the means for generating electrical energy 8) for detecting variations in irradiation and/or a current sensor configured to detect the intensity of electric current generated by the means for generating electrical energy 8, and to thus send a corresponding detection signal to said electronic control unit 9.

More in detail, suitably, the first sensor means of the means for generating electricity 8 can comprise at least one irradiation sensor (also known by the technical term of solarimeter, i.e. a solar radiation sensor) for detecting variations in irradiation and/or a configured current sensor to detect the intensity of electric current generated by said means for generating electrical energy 8.

Conveniently, the detection signal contains information on the variation of irradiation and/or on the variation of intensity of electric current generated by said means for generating electricity 8 and/or on the variation of the measurement of flow rate and/or or on the variation of the pressure measurement of said flow of fluid to be treated.

Advantageously, the electronic control unit 9 is configured to command the regulating valve 7 to close in a proportional manner with respect to the aforementioned variation measured by the sensor means.

For example, a decrease in irradiation will be followed by a proportional closure of the regulating valve 7 in order to maintain constant fluid flow and/or pressure.

Advantageously, the regulating valve 7 requires a small electrical power supply, i.e. for example a few mW.

As is known per se, photovoltaic fields are likely to vary the electrical power they produce on the basis of the variation in solar radiation that affects them. For example, a cloudy day will allow the photovoltaic field to produce less electrical power than a sunny day.

In this situation, the means for generating electrical energy 8 supply a variable electrical power supply to the first pumping means 6 and, preferably to the second pumping means 17, and consequently also the flow of fluid to be treated which affects the inverse osmosis devices 3, 4, 15 and 29 is variable.

Preferably, the interception and/or regulation valve 7 is configured to be operated to completely and/or partially close a first supply branch 5′ and therefore completely interrupt and/or decrease the first flow of water towards the first device 3 to reverse osmosis to consequently increase the second flow of fluid to be treated and allow the second device 4 to always function optimally.

More in detail, the first sensor means of the means for generating electrical energy 8 generate the first detection signal, for example in correspondence with a decrease in the production of energy and/or electrical power.

Otherwise, the first sensor means of the means for generating electrical energy 8 are configured to detect in a substantially continuous manner (i.e. at a predetermined sampling frequency) the value of power and/or electrical energy, whether it is by means of an irradiation value or a value of electric current and/or electric power.

Advantageously, the electronic control unit 9 comprises a receiving module configured to receive, preferably continuously, the first detection signal sent by the first sensor means of the means for generating electricity 8.

In particular, the irradiation sensor 39 detects a decrease in solar irradiation in correspondence with the photovoltaic field and generates the aforementioned corresponding first detection signal and sends it to the electronic control unit 9. Otherwise, the irradiation sensor 39 continuously detects the irradiation value and sends it the value contained within the first detection signal to the electronic control unit 9.

Conveniently, the system 1 according to the invention also comprises second sensor means 11 positioned on or in correspondence with the supply duct 5, preferably upstream of the first treatment unit 2, electronically connected to the electronic control unit 9 and configured to detect a measurement of the flow rate and/or pressure of said flow of fluid to be treated and to send a corresponding detection signal to said electronic control unit.

Advantageously, the second sensor means continuously detect (i.e. at a certain sampling frequency) the flow rate and/or pressure of said flow of fluid to be treated and send a corresponding second detection signal to the electronic control unit 9, and in particular to the receiving module of the electronic control unit 9.

For example, the second sensor means 11 comprise at least a flow meter and/or a manometer placed to intercept the supply duct 5 and advantageously electronically connected to the electronic control unit 9.

Advantageously, the system according to the invention can comprise only the first sensor means or only the second sensor means 11 or it can conveniently comprise both the first and the second sensor means.

Conveniently, said electronic control unit 9 comprises at least one processing module configured and/or programmed to receive said detection signal sent by said sensor means and process said signal.

In more detail, moreover, the electronic control unit 9 comprises at least the processing module configured and/or programmed to receive the first and/or second detection signal sent by the corresponding first and/or second sensor means and process these signals.

More in detail, the processing module allows to compare the electric power production value generated by the first sensor means with a predetermined threshold value and/or to compare the pressure and/or flow rate value sent by the second sensor means with a corresponding predetermined threshold value.

For this purpose, the electronic control unit 9 further comprises at least one memory electronically connected to the processing module and containing at least the aforementioned predetermined threshold values.

Conveniently, if the value detected by the first and/or second sensor means deviates, in particular by default, with respect to the respective predetermined threshold values, the processing module of the electronic control unit 9 is configured to generate a corresponding command signal.

The command signal generated by the processing module is therefore advantageously sent to the command module to command said at least one interception and/or regulation valve 7 to completely close and/or at least partially decrease the first branch 5′ of the supply duct 5 to in order to consequently increase the flow of fluid to be treated in the second branch 5″ and thus advantageously bring it back above a predetermined threshold value.

Conveniently, a first discharge duct 12 for permeate fluid and a second discharge duct 13 for concentrated fluid develop from each reverse osmosis filtration device 3 and 4 of the first treatment unit 2.

The plant 1 conveniently comprises at least one throttling valve 10 which is mounted in correspondence with said second discharge duct 13 of concentrated fluid of at least one reverse osmosis filtration device 15. Furthermore, the electronic control unit 9 is electronically connected to said throttling valve and is programmed to correspondingly command, following the reception of at least one detection signal, the closing and/or opening of said throttling valve 10 to vary the passage section of the concentrated fluid through said valve 10, and thus at least partially vary the pressure inside said reverse osmosis filtration device 15.

Preferably, the throttling valve 10 is controlled to completely or partially throttle the second exhaust duct 13 and thus at least partially increase the pressure inside the corresponding reverse osmosis filtration device.

More in detail, the aforementioned electronic control unit 9 is electronically connected to the throttling valve 10 and is programmed to correspondingly control, following the reception of at least one detection signal, the opening and/or closing of the throttling valve 10 for completely or partially throttling the passage section of the concentrated fluid through said valve 10 inside the second discharge duct 13, and thus at least partially increasing the pressure inside the reverse osmosis filtration device 3, 4, 15, 29.

Advantageously, the reverse osmosis filtration device 3, 4, 15, 29 is configured to implement tangential filtration of the fluid to be treated and, as mentioned, comprises at least two zones 31 and 32, in which the first zone 32 is in fluid communication with the permeate outlet while the second zone 31, containing the windings of the membrane 33, is in fluid communication with the inlet of the fluid to be treated and with said outlet of the concentrate.

The term “permeate fluid” must hereinafter be understood as a fluid, and in particular water, that is filtered or has a lower salinity than the fluid to be treated, i.e. sea and/or brackish water.

The term “concentrated fluid” will be understood in the following as a fluid, and in particular water, with high salinity or unfiltered water and also containing the salt removed from the filtered (permeated) water and expelled through the aforementioned permeated fluid.

Operationally, the throttling valve 10 is configured to completely or partially throttle the second discharge duct 13 of concentrated fluid, in order to vary (i.e. decrease or increase) the fluid passage section and consequently vary (i.e. decrease or increase) the pressure inside the reverse osmosis filtration devices to compensate for the pressure variations, caused by the variations in the electrical energy supplying the pumps caused by the variations in irradiation, during the normal use of the photovoltaic type means for generating electricity 8.

Conveniently, the aforementioned electronic control unit 9 is electronically connected to the throttling valve 10 and is programmed to activate said throttling valve 10 to at least partially throttle the second discharge duct 13 (of concentrated fluid) following the receipt of at least the aforementioned detection signal.

In other words, preferably, the aforementioned at least one electronic control unit 9 is configured to cause the closure of the throttling valve 10 provided in the second discharge duct 13 so that the pressure in said second zone 31 of the device is always higher than a predefined minimum threshold value PMIN.

Advantageously, the processing module of the electronic control unit 9 is configured and/or programmed to receive the first and/or second detection signal sent by the corresponding first and/or second sensor means and to process these signals to generate a corresponding command signal, in accordance with what is described above.

The command signal generated by the processing module is therefore advantageously sent to the command module to command the closing and/or opening of the aforementioned throttling valve 10 so as to vary the section of passage of the concentrated fluid through said valve 10, and thus vary at least partially the pressure inside said reverse osmosis filtration device. Preferably, the control signal causes at least partial throttling of the throttling valve 10 of the second discharge duct 13, to consequently increase the pressure inside the corresponding reverse osmosis filtration device 3, 4, 15 and/or 29 connected to said second exhaust duct 13.

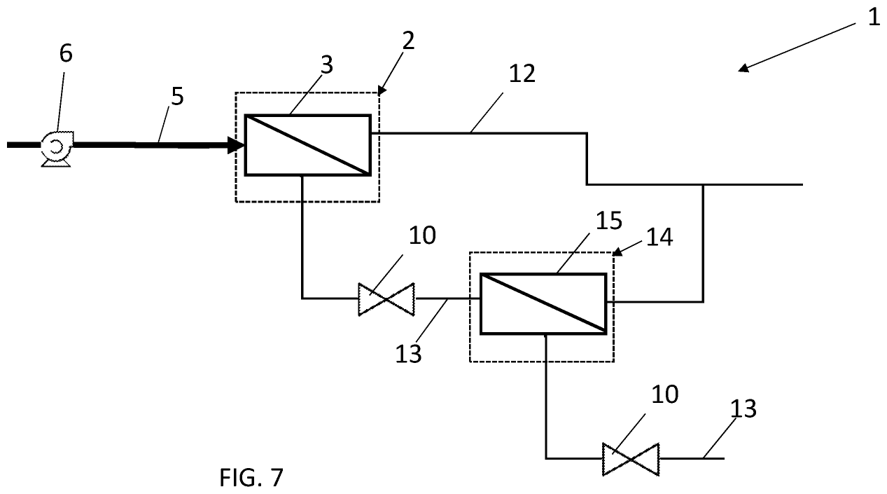

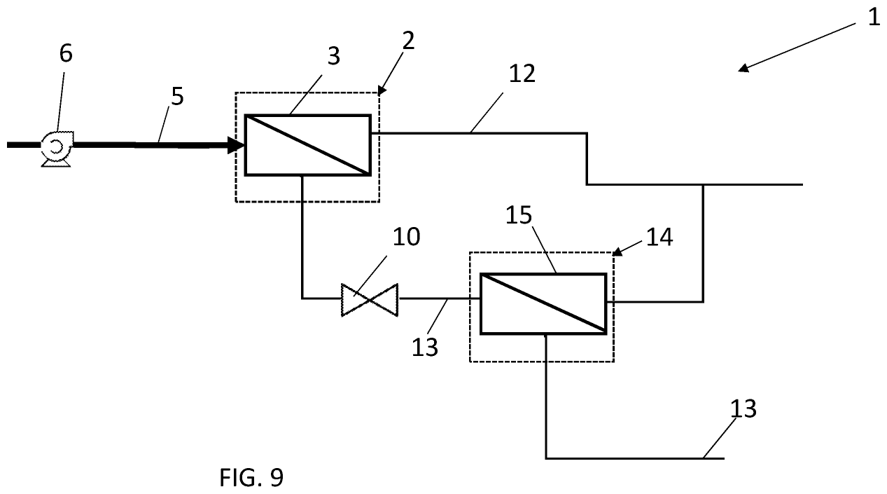

In accordance with a particular embodiment of the system 1 (see for example FIGS. 7 and 9), the aforementioned at least one throttle valve 10 is mounted in correspondence with the second exhaust duct 13 of concentrated fluid of at least one reverse osmosis filtration device 3 of a treatment unit 2 which defines the only treatment unit of said plant or an upstream treatment unit of a plant with two or more treatment units in cascade.

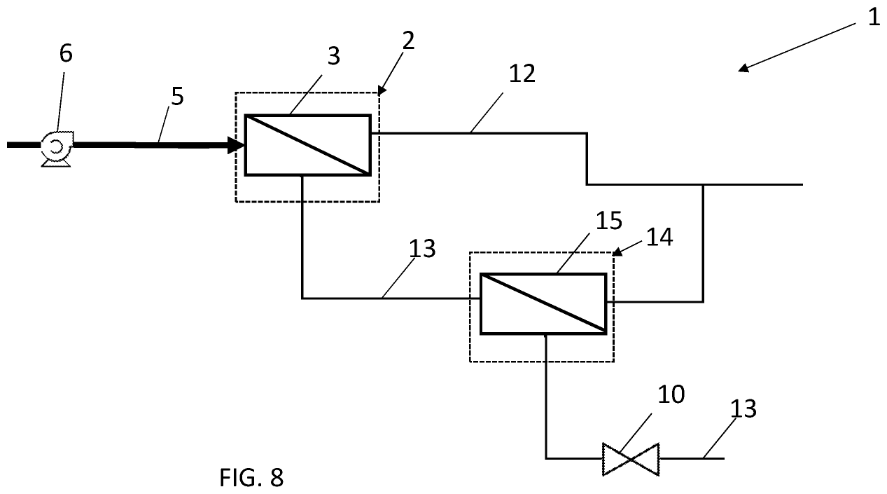

Otherwise, in accordance with a further embodiment of the plant 1 according to the invention (see for example FIGS. 7 and 8), the aforementioned at least one throttling valve 10 is mounted in correspondence with the second discharge duct 13 of concentrated fluid of at least one reverse osmosis filtration device 15 of a second treatment unit 14 which is positioned immediately downstream from a first upstream treatment unit 2.

Advantageously, the shut-off and/or regulation valve 7 and/or the valve choke 10 can be an on-off type valve, that is, provided with an opening configuration and a closing configuration.

Advantageously, the interception and/or regulation valve 7 and/or the throttling valve 10 can be a valve of the proportional type.

Advantageously, the interception and/or regulation valve 7 and/or the throttling valve 10 is configured to have a gradual and progressive closing or opening.

More in detail, the interception and/or regulation valve 7 and/or the throttling valve 10 can be moved between an opening configuration in which it frees the passage of fluid and a closed configuration in which it prevents the passage of fluid in a preferably controlled manner, as a function of the pressure of the fluid that passes through it and also preferably provides a plurality of intermediate configurations of partial opening/closing, to thus choke the flow of the fluid that passes through it.

Preferably, the shut-off and/or regulation valve 7 is configured and/or controlled to close gradually, preferably so as to cause a change in the pressure of the fluid entering the corresponding reverse osmosis filtration device, lower than about 1 bar/s preferably less than 0.5 bar/sec.

In this way, if, for example, the pressure of the fluid intercepted by the interception and/or regulation valve 7 and/or by the throttling valve 10 is 20 bar, the movement between the opening configuration and the closing configuration takes place in at least 20 seconds and preferably in at least 40 seconds.

More generally, the first treatment unit 2 can conveniently comprise a first plurality of N reverse osmosis filtration devices and the plant comprises a plurality of first shut-off and/or regulation valves 7 placed upstream of N or N−1 said devices reverse osmosis.

Conveniently, the treatment unit 2, 14 upstream and/or downstream and/or the only one in the plant 1 according to the invention, comprises at least two first reverse osmosis filtration devices 3, arranged in parallel with each other and with respect to the second device 4, and by the fact that it comprises at least two shut-off and/or regulation valves 7, each of which is placed upstream of a corresponding first reverse osmosis filtration device 3.

In other words, the plant 1 according to the invention advantageously provides a number of first interception and/or regulation valves 7 which is lower than one unit with respect to the number of reverse osmosis filtration devices of the first treatment unit 2.

The system 1 according to the invention preferably comprises a second treatment unit 14 located to shut off the second concentrated fluid discharge duct 13 and comprising at least a third reverse osmosis filtration device 15 configured to filter the discharged fluid at the outlet from the first treatment unit 2.

Advantageously, the second treatment unit 14 comprises a second plurality of reverse osmosis filtration devices, and the aforementioned first plurality of first throttling valves 7 is arranged upstream of the first plurality of reverse osmosis filtration devices of the first treatment unit 2 and/or upstream of the second plurality of reverse osmosis filtration devices of the second treatment unit 14.

More generally, the aforementioned at least one interception and/or regulation valve 7 can be provided upstream of at least one osmosis device of a said treatment unit 2, 14, in which there are at least two reverse osmosis filtration devices connected to each other and/or arranged in parallel, without thereby departing from the scope of protection of this patent.

For example, the second treatment unit 14 may comprise two or more treatment devices 15 arranged in parallel with each other, in which the respective second discharge ducts 13 of concentrated fluid define the branches of the supply duct 5 configured to be crossed by the fluid to be treat, in accordance with the vocabulary used in this description.

The aforementioned throttling valve 10 is advantageously provided downstream of the second treatment unit 14 to shut off said second discharge duct 13 of concentrated fluid leaving said second treatment unit 14.

Obviously, the aforementioned throttling valve 10 can be provided to intercept the second discharge duct 13 downstream of the first treatment unit 2, whether or not the plant also includes the second treatment unit 14.

Conveniently, the throttling valve 10 is configured to throttle the second discharge duct 13 of concentrated fluid to increase the pressure inside at least one reverse osmosis filtration device of the first treatment unit 2 and/or preferably inside the second treatment unit 14.

In accordance with an embodiment not shown, the plant 1 according to the invention provides that each reverse osmosis filtration device 3, 4, 15 has a corresponding first discharge duct 12 (of permeate fluid) and a corresponding to said second discharge duct 13 (of concentrated fluid). The plant conveniently provides at least one throttling valve 10 positioned to intercept each second discharge duct 13 of concentrated fluid.

In this way, the plant object of the present invention advantageously allows to keep the pressure inside each reverse osmosis filtration device 3, 4, 15 above a predetermined threshold value.

Preferably, the throttling valve 10 is suitably configured to be operated by the electronic control unit to throttle the second exhaust duct 13 to increase the pressure inside the reverse osmosis filtration devices in the event that the pressure inside them, such as for example, due to a decrease in the flow of fluid to be treated, it falls below a predetermined threshold value.

In this way, the plant according to the invention allows the flow and pressure to be maintained above predetermined threshold values by means of the selective and controlled actuation of the interception and/or regulation valve 7 and/or of the throttling valve 10 as described above.

The plant treated so far has been described, purely by way of example, with the first treatment unit 2 comprising two reverse osmosis filtration devices 3, 4. Obviously, this first treatment unit 2 may comprise three or more reverse osmosis filtration devices without for this to come out of the protective suit of this patent.

Furthermore, the plant according to the invention may comprise two or more first valves 7 placed to intercept respective branches of the supply duct to thus allow an increase in the flow in the remaining branches of the supply duct itself, and prevent it from falling below of the flow threshold values foreseen for each reverse osmosis filtration device.

Similarly, the plant according to the invention may comprise further second treatment units 14 provided for interception of corresponding second discharge ducts 13 of concentrated fluid which develop starting from corresponding reverse osmosis filtration devices of the first treatment unit 2.

The present invention also relates to a control method of a desalination plant of the type described above and of which, for the sake of simplicity, the same numerical references will be maintained.

The control method of a desalination plant according to the invention provides that the electronic control unit 9 receives at least one detection signal from the first sensor means and/or the second sensor means.

Conveniently, the method therefore provides that, on the basis of the detection signal, the electronic control unit 9 generates at least one corresponding command signal.

Advantageously, the electronic control unit 9 sends the command signal to the interception and/or regulation valve 7 to cause its complete and/or partial closure so as to interrupt and/or partially reduce the flow of fluid to be treated at the inlet of the first device 3, and thus increase the flow of fluid to be treated entering the at least one second device 4.

Conveniently, the electronic control unit 9 sends the command signal to the throttling valve 10 to at least partially throttle the second duct 13 and thus at least partially increase the pressure inside said reverse osmosis filtration device 3, 4, 15.

Advantageously, on the basis of said received detection signal, the electronic control unit 9 generates at least a corresponding second command signal. The electronic control unit 9 conveniently sends the second command signal to a throttling valve 10 positioned on the concentrate outlet duct 13 of a reverse osmosis filtration device 3, 4, 15 for desalination, to at least partially throttle the concentrate outlet duct and thus increase the pressure inside said device 3, 4, 15.

As is clear from what has been said, the desalination plant according to the invention is particularly advantageous in that:
it is perfectly reliable even if powered by means for the generation of renewable electricity which could have significant and even sudden variations in the values of electrical power generated;
allows the reverse osmosis membranes to be used in an optimal way in all weather conditions and thus to increase their useful life, in particular thanks to the fact that this avoids stresses to the membranes of the devices beyond the flow parameters recommended by the manufacturers;
it is constructively simple and completely reliable;
it allows to limit management costs, and in particular it allows to limit maintenance costs;
allows it to be used continuously throughout an operating day;
it is easily achievable and with low costs;
it is an alternative and/or improvement to the known solutions.

The present invention has been illustrated and described in a preferred embodiment thereof, but it is understood that executive variations may be applied to it in practice, without however departing from the scope of protection of the present patent for industrial invention.

1. Renewable energy desalination plant (1) for the treatment of a fluid, in particular water, comprising:
at least one treatment unit (2, 14) equipped with at least a first reverse osmosis filtration device (3, 15) for desalination of a flow of fluid to be treated and at least a second osmosis filtration device (4, 29) inverse for desalination of a flow of fluid to be treated, said at least one second device (4, 29) and said at least one first device (3, 15) being connected in parallel;
first pumping means (6) positioned upstream of said at least one treatment unit (2, 14);
means for generating electrical energy (8) from renewable energy for a electrical supply of said first pumping means (6),
at least one supply duct (5) which is fluidically and separately connected with an inlet of said at least one first device (3, 15) and with an inlet of said at least one second device (4, 29) of said at least one unit treatment system (2, 14), to supply said two devices (2, 4) with said fluid to be treated,
at least one shut-off and/or regulating valve (7) which is positioned at a fluidic connection of said supply duct (5) with said at least one first device (3, 15),
at least one electronic control unit (9) which is electronically connected to said at least one shut-off and/or regulating valve (7) and which is programmed to command, following reception of at least one detection signal, complete or partial closure of said shut-off and/or regulating valve (7) so as to interrupt or decrease the flow of fluid to be treated at the inlet of said at least one first device (3, 15) and thus increase the flow of fluid to be treated at the inlet of said at least one second device (4, 29);
electronic sensor means which are connected to said at least one electronic control unit (9) and which are configured to detect irradiation and/or to detect an intensity of electric current generated by said means for generating electrical energy (8) and/or to detect a measurement of flow rate and/or pressure of said flow of fluid to be treated, and to thus send a corresponding said detection signal to said at least one electronic control unit (9).

2. The desalination plant (1) according to claim 1, wherein said shut-off and/or regulating valve (7) is:
provided only in correspondence with the fluidic connection of said supply duct (5) with said at least one first device (3, 15) and is connected at the inlet with said supply duct (5) and at the outlet is fluidically connected only with said at least one first reverse osmosis filtration device (3, 15),
selectively controlled in full or partial closing/opening to interrupt or decrease only the flow of fluid to be treated at the entrance to said at least one first device (3, 15), and thus increase the flow of fluid to be treated at the entrance to said at least one second device (4, 29).

3. The desalination plant (1) according to claim 1, further comprising at least one further shut-off and/or regulating valve (7) which is positioned in correspondence with the fluidic connection of said supply duct (5) with said at least one second device (4, 29), wherein said at least one electronic control unit (9) is electronically connected to said at least one further shut-off and/or regulating valve (7) and is programmed to control, upon receipt of at least a detection signal, alternatively:
the complete or partial closure of said at least one further shut-off and/or regulating valve (7) so as to interrupt or decrease the flow of fluid to be treated at the inlet of said at least one second device (4, 29) and thus increase the flow of fluid to be treated in input to said at least one first device (3, 15),
the complete or partial closure of said shut-off and/or regulating valve (7) so as to interrupt or decrease the flow of fluid to be treated at the inlet of said at least one first device (3, 15) and thus increase the flow of fluid to be treated in input to said at least one second device (4, 29).

4. The desalination plant (1) according to claim 1, wherein said shut-off and/or regulating valve (7) is connected at the inlet with a supply duct (5) provided with first pumping means (6), to send the fluid to be treated inside a first treatment unit (2), and at the outlet it is fluidically connected only with said at least one first reverse osmosis filtration device (3) of said first treatment unit (2) which, defines the only treatment unit of said plant or an upstream treatment unit of a plant with two or more treatment units in cascade.

5. The desalination plant (1) according to claim 1, wherein said shut-off and/or regulating valve (7):
at the inlet is fluidically connected to a supply duct (5) which is fluidly connected to the concentrate outlet of at least one reverse osmosis filtration device of a first upstream treatment unit,
at the outlet it is fluidly connected only with said at least one first reverse osmosis filtration device (3) of a second treatment unit (14) which is positioned immediately downstream of said first upstream treatment unit (2).

6. The desalination plant (1) according to ene claim 1, further comprising first sensor means electronically connected to said at least one electronic control unit (9) and at least one irradiation sensor for detecting changes in irradiation and/or a current sensor configured to detect electric current intensity generated by said means for generating electrical energy (8), and to thus send a corresponding detection signal to said at least one electronic control unit (9).

7. The desalination plant (1) according to claim 6, further comprising second sensor means (11) positioned on said supply duct (5) upstream of said first treatment unit (2), electronically connected to said at least one electronic control unit (9) and configured to detect a measurement of flow rate and/or pressure of said flow of fluid to be treated and to send a corresponding detection signal to said at least one electronic control unit (9).

8. The desalination plant (1) according to claim 1, wherein said treatment unit (2, 14), upstream and/or downstream and/or unique in said plant, comprises at least two first devices for reverse osmosis filtration (3), arranged in parallel with each other and with respect to said second device (4), and at least two shut-off and/or regulation valves (7), each of which is placed upstream of a corresponding first reverse osmosis filtration device (3).

9. The desalination plant (1) according to claim 6, wherein said detection signal sent from said sensor means includes detection magnitudes and/or measuring all directly or indirectly dependent from solar radiation.

10. The desalination plant (1) according to claim 6, wherein said detection signal sent by said sensor means contains information on a variation of irradiation and/or on the variation of intensity of electric current generated by said means for generating electrical energy (8) and/or on the variation of the flow rate measurement and/or on the variation of the pressure measurement of said flow of fluid to be treated.

11. The desalination plant (1) according to claim 6, wherein said at least one electronic control unit (9) is configured to command the regulating valve (7) to close in a proportional manner with respect to the aforementioned variation measured by sensor means.

12. The desalination plant (1) according to ese claim 7, wherein said at least one electronic control unit (9) comprises at least one processing module configured and/or programmed to receive said detection signal sent from said means sensors and process said signal.

13. The desalination plant (1) according to claim 12, wherein said at least one processing module of said at least one electronic control unit (9) is configured to compare a production value of electric power generated by the means for generating electrical energy (8) with a predetermined threshold value and/or to compare the pressure and/or flow rate value with a corresponding predetermined threshold value.

14. The desalination plant (1) according to claim 13, wherein if the value detected by the sensor means deviates, in particular, failing that, with respect to the respective predetermined threshold values, the at least one electronic control unit processing module (9) is configured to generate a corresponding command signal.

15. The desalination plant (1) according to claim 14, wherein said control signal generated by the processing module is then sent to a control module of said at least one electronic control unit (9) for controlling said at least one shut-off and/or regulating valve (7) to completely close and/or at least partially decrease a first branch (5′) of the supply duct (5) in order to consequently increase the flow of fluid to be treated in a second branch (5″) and bring it back above a predetermined threshold value.

16. The desalination plant (1) according to ene claim 1, wherein said at least one electronic control unit (9) is configured so that, if the flow entering both reverse osmosis filtration devices in parallel is lower than a predetermined threshold value, following a closure of said shut-off and/or regulating valve (7), then correspondingly commands the deactivation/blocking of said first pumping means (6).

17. The desalination plant according to claim 1, wherein:
said at least one electronic control unit (9) receives at least one detection signal from said sensor means;
on the basis of said at least one detection signal, said at least one electronic control unit (9) generates at least one corresponding first command signal;
said electronic control unit sends said first command signal to said interception and/or regulation valve (7) to cause a complete or partial closure thereof so as to interrupt or decrease the flow of fluid to be treated at the inlet of said first device (3), and thus increase the flow of fluid to be treated entering said at least one second device (4).

18. The desalination plant according to claim 17, wherein:
on the basis of said received at least one detection signal, said at least one electronic control unit (9) generates at least one corresponding second command signal;
said electronic control unit sends said at least one corresponding second command signal to a throttling valve (10) positioned on a concentrate outlet duct (13) of one of the first or second reverse osmosis filtration devices (3, 4, 15, 29) for desalination, to vary the section of passage of the concentrated fluid through said valve (10), and thus at least partially vary the pressure inside said reverse osmosis filtration device (3, 4, 15, 29).
